(19) United States
(12) Patent Application Publication
(10) Pub. No.: US 2012/0107508 A1
(43) Pub. Date: May 3, 2012

(54) POLYURETHANE FLOOR FINISHES WITH HYBRID PERFORMANCE

(75) Inventors: Minyu Li, Oakdale, MN (US); Nathan D. Peitersen, Richfield, MN (US); Mark D. Levitt, Lake Elmo, MN (US); Lauren K. Carlson, St. Paul, MN (US); Robert D. Hei, Baldwin, WI (US); Anita Thomasser, New Brighton, MN (US); Catherine Hanson, Hastings, MN (US)

(73) Assignee: ECOLAB USA INC., St. Paul, MN (US)

(21) Appl. No.: 13/105,213

(22) Filed: May 11, 2011

Related U.S. Application Data
(63) Continuation of application No. 12/901,128, filed on Oct. 8, 2010, now abandoned.

(51) Int. Cl. B05D 3/12; C08K 5/101; B05D 1/28; C09D 175/04

(52) U.S. Cl. 427/355; 524/591; 524/317; 524/315; 524/873; 524/839; 427/429

(57) ABSTRACT

VOC-compliant aqueous polyurethane floor coating compositions and components are provided. Embodiments include at least one organic solvent having a vapor pressure of less than 0.1 mm Hg under ambient conditions and a viscosity of less than 60 cps for at least three hours after being formed. The coating compositions exhibit application characteristics of acrylic floor coatings and durability characteristics of polyurethane floor coatings.

### RELATED APPLICATION

This application is a continuation of U.S. patent application Ser. No. 12/901,128, filed Oct. 8, 2010 entitled “POLYURETHANE FLOOR FINISHES WITH HYBRID PERFORMANCE.

### TECHNICAL FIELD

Embodiments of the present invention relate generally to floor finishes, and more particularly to multi-component polyurethane floor finishes.

### BACKGROUND

Conventional floor finishes are periodically applied to a variety of flooring types (wood, vinyl, composite, terrazzo, stone, etc.) to improve use life and to enhance the visual appearance of the floor. For example, conventional acrylic based polymer finishes have a low viscosity and may be applied by simple mopping techniques. In contrast, “ultradurable” floor finishes utilize highly cross-linked polymer chemistry such as multi-component polyurethane materials. These polyurethane finishes provide a high viscosity product, which can be applied in one or two coats, but also require special application skills and equipment. Additionally, the pot life of such polyurethanes is significantly shorter than acrylic polymer finishes.

It would be beneficial to provide a floor finish having the durability of polyurethane finishes and the ease of application of acrylic polymer finishes. It would also be beneficial to apply such finishes using VOC-compliant compositions. “VOC” refers to volatile organic compounds, which have been the subject of regulation by different government entities, the most prominent regulations having been established by the California Air Resource Board in its General Consumer Products Regulation.

### SUMMARY

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

One embodiment of the invention provides a floor coating composition including an aqueous dispersion of at least one polyurethane material and a solvent system. The solvent system in one embodiment has no more than 1 wt % organic solvent having a vapor pressure of greater than 0.1 mm Hg at 20° C. The solvent system in another embodiment includes at least one aprotic solvent, and more particularly, at least one aprotic solvent having a vapor pressure of less than 0.1 mm Hg at 20° C. Particularly suitable solvents that may be included in the solvent system include dipropylene glycol methyl ether acetate solvent and 3-methoxybutyl acetate solvent. Embodiments of the present invention may have a viscosity of less than 60 cps for at least 3 hours after being formed.

Another embodiment is a floor finish system including a first component comprising at least one polyol or polyol derivative and a second component including at least one polyisocyanate or polyisocyanate derivative. The first and second components may be free of N-methylpyrrolidone and include no more than 1 wt % organic solvent having a vapor pressure of greater than 0.1 mm Hg at 20° C. based on the total weight of the first and second components. The floor finish system may be packaged in separate reservoirs as a two component system or together as a one component system.

A further embodiment is a method of coating a floor with the composition and/or system described above. The coating material applied to the floor may dry to the touch in less than 60 minutes, more particularly, less than 45 minutes, and may be burnished to restore gloss.

### BRIEF DESCRIPTION OF THE DRAWINGS

FIGS. 1A-B are bar graphs illustrating gloss properties of embodiments of the present invention.

FIGS. 2A-B are bar graphs illustrating gloss properties of additional embodiments of the present invention.

FIGS. 3A-3C are bar graphs illustrating gloss properties of additional embodiments of the present invention.

FIG. 4 illustrates abrasion resistance properties of embodiments of the present invention.

FIG. 5 is a bar graph illustrating gloss properties of additional embodiments of the present invention.

FIG. 6 is a bar graph illustrating gloss properties of additional embodiments of the present invention.

FIG. 7 is a line graph illustrating burnish properties of an embodiment of the present invention.

### DETAILED DESCRIPTION

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

Embodiments of the present invention provide polyurethane-based floor finish formulations. One embodiment of the present invention is a multi-component floor finish system, in which the components are combined under conditions suitable to form a low viscosity polyurethane coating material. A first component of the system is an aqueous polymer dispersion including at least one polyol material and optionally at least one wax material. A second component of the system includes a polyisocyanate material and at least one organic solvent. When combined the two components include a solvent system having no more than 1 wt % organic solvent having a vapor pressure of greater than 0.1 mm Hg at 20° C.

A variety of water dispersible polyols may be included in the first component. Suitable polyols include linear, branched or cyclic polyalkyl, polyalkene and polyalkenyl polyols, polyether polyols, fluoropolymer polyols, polyester polyols, poly(acrylate)polyols, poly(methacrylate)polyols, polysiloxane polyols, polycarbonate polyols and polyurethane polyols. The first component may constitute between about 15 wt % and 90 wt % polyol (i.e., percent solids), more particularly, between about 25 wt % and 75 wt % polyol and even more particularly, between about 30 wt % and about 60 wt % polyol.

Specific examples of commercially available polyols include QWF4744 available from Henkel, which is an aqueous solution of an OH functional polyol based resin. Another example is SF5000, which is a solvent-free water based hydroxyl functional polyol resin. Additional commercially available polyols include polytetramethylene oxide diols and polyhexamethylene diols, which are available from various sources including Sigma-Aldrich Co., Saint Louis, Mo., USA and E. I. DuPont de Nemours and Co., Wilmington, Del., USA. Examples of polysiloxane polyol materials include polydimethylsiloxane diols, available from various sources including Dow Corning Corp., Midland Mich., USA, Chisso Corp., Tokyo, Japan. Examples of suitable polycarbonate polyol materials include polyhexamethylene carbonate diols such as those available from Sigma-Aldrich Co. Examples of polyfluoroalkylene oxide diol materials include ZDOLTX, Ausimont, Bussi, Italy. Suitable polystyrene diol materials (α,ω-dihydroxy-terminated polystyrene) of varying molecular weight are available from Polymer Source, Inc., Montreal, Canada.

The first component may further include one or more optional chain extender residues and/or end groups. Chain extenders are typically formed from aliphatic or aromatic diols (in which case a urethane bond is formed upon reaction with an isocyanate group) or aliphatic or aromatic diamines (in which case a urea bond is formed upon reaction with an isocyanate group). Suitable chain extenders may include alpha, omega-alkane diols such as ethylene glycol (1,2-ethane diol), 1,4-butanediol, 1,6-hexanediol, alpha,omega-alkane diamines such as ethylene diamine, dibutylamine(1,4-butane diamine) and 1,6-hexanediamine, or 4,4′-methylene bis(2-chloroaniline). Other suitable chain extenders are short chain diol polymers (e.g., alpha,omega-dihydroxy-terminated polymers having a molecular weight less than or equal to 1000) including short chain polyisobutylene diols, polyether polyols such as polytetramethylene oxide diols, polysiloxane diols such as polydimethylsiloxane diols, polycarbonate diols such as polyhexamethylene carbonate diols, poly(fluorinated ether)diols, polyester diols, polyacrylate diols, polymethacrylate diols, and poly(vinyl aromatic)diols.

Optional wax materials that may be added to the first component include plant, animal and petroleum derived waxes that are present as an emulsion in the aqueous component. Suitable petroleum waxes include polyethylene waxes, polypropylene waxes and combinations thereof. Suitable polyethylene waxes may be oxidized or co-polymerized with acrylic acid to give the polyethylene chemical functionality which allows it to be emulsified in the aqueous solution. Polyethylene materials that are free of functional groups may also be used. The polyethylene may be classified as high density polyethylene (HDPE) or low density polyethylene (LDPE). HDPE is higher melting (110° C.-140° C./230° F.-284° F.) and is harder. LDPE is lower melting (100° C.-110° C./212° F.-230° F.) and softer. The wax may also be classified as non-ionic, cationic or anionic.

Particularly suitable polyethylene waxes include non-ionic HDPE waxes with non-ionic emulsifiers having a melting point between 100° C. and 150° C., more particularly, between 110° C. and 140° C., and even more particularly, between 130° C. and 140° C. The wax may also have a hardness of less than 1.0 decimillimeters of needle penetration. An example of a commercially available polyethylene wax is Poly Emulsion 325G available from ChemCor. In one embodiment, the first component includes between about 0.5 wt % and 10 wt % wax, more particularly, between about 1.0 and 5.0 wt % wax.

As noted above, the first component is in the form of an aqueous solution or dispersion. In one embodiment, the aqueous solution is also free of N-Methylpyrrolidone (NMP) solvent, whose use is subject to regulation. In another embodiment, the first component is VOC-compliant and/or VOC-free. The solution or dispersion may have a solids content of from about 5 wt % to about 50 wt %, more particularly, from about 10 to about 30 wt %, even more particularly, from about 12 to about 25 wt %. The aqueous solution or dispersion may have a solids content of less than 30 wt %, more particularly, less than about 25 wt %, even more particularly, less than about 20 wt %, and even more particularly, from about 10 wt % to about 20 wt %.

The second component of the system includes at least one polyisocyanate material and optionally an organic solvent system. Suitable polyisocyanates include a hydrophilically modified trimer of hexamethylene diisocyanate (HDT) and a hydrophilically modified trimer of isophorone diisocyanate (IPDT) and blends thereof. Additional suitable polyisocyanates may be derived from aromatic and non-aromatic (e.g., aliphatic) diisocyanates. Aromatic diisocyanates include 4,4′-methylenediphenyl diisocyanate (MDI), 2,4- and/or 2,6-toluene diisocyanate (TDI), 1,5-naphthalene diisocyanate (NDI), paraphenylene diisocyanate, 3,3′-toluidene-4,4′-diisocyanate and 3,3′-dimethyl-diphenylmethane-4,4′-diisocyanate. Non-aromatic diisocyanates include 1,6-hexamethylene diisocyanate (HDI), 4,4′-dicyclohexylmethane diisocyanate, 3-isocyanatomethyl-3,5,5-trimethylcyclohexyl isocyanate (isophorone diisocyanate or IPDI), cyclohexyl diisocyanate, 2,2,4-trimethyl-1,6-hexamethylene diisocyanate (TMDI). Blocked polyisocyanates may also be suitable. Particularly suitable commercially available polyisocyanate include Rhodocoat EZ-M502 and Rhodocoat X EZ-D 803 both available from Rhodia and Easaqua XM 502 available from Perstorp.

Suitable organic solvent systems optionally included in the second component may include no more than 1 wt % organic solvent having a vapor pressure of greater than 0.1 mm Hg at 20° C. to render the coating material VOC-compliant. In certain embodiments the solvent system may include one or more aprotic solvents, which may have a vapor pressure of less than 0.1 mm Hg at 20° C. Particular solvents include ether ester solvents, more particularly, aliphatic glycol alkyl ether acetate solvents. Specific examples of solvents that may be included in the solvent system include dipropylene glycol methyl ether acetate and 3-methoxy butyl acetate. In some embodiments, the second component may constitute between about 5 wt % and about 50 wt % solvent system, more particularly, from about 10 wt % to about 25 wt % solvent system, even more particularly, from about 10 wt % to about 20 wt % solvent system.

The first or second component may also include various additional additives such as surfactants, defoamers, surface tension modifiers, leveling agents, air release agents, catalysts, flattening agents, plasticizers, functional polymers, hydrophilicity/hydrophobicity enhancers, particles such as colloidal particles, preservatives and coloring agents. Examples of suitable commercially available surfactants include polyether siloxane surfactants such as Tego Foamex 805 available from Tego. Suitable defoamers include SE-21 available from Wacker. Suitable colloidal particles include Bindzil CC30 available from Akzo Nobel. Suitable polymeric additives include polyurethanes, polyacrylics and polyesters. Suitable leveling agents include low molecular weight acrylic resins and urea resins. Suitable catalysts include dibutyl tin dilaurate, zinc octoate, and long chain tertiary amines.

Furthermore, the inventive polyurethane-based floor finishes can be coated on top of a sealer to improve the coating performance, such as adhesion to substrate or/and strip-ability. Exemplary sealer polymers include, but are not limited to, zinc free or zinc containing acrylic polymers, polyurethanes, epoxy resins, polyesters, polycarbonates and its copolymers, polystyrene and its copolymers and polyvinyl alcohol and its copolymers. Normally, 1 to 2 sealer coatings may be applied prior to applying the polyurethane finish.

The first and second components are combined prior to use to form a polyurethane coating material that may be applied to a variety of flooring materials including vinyl sheet, vinyl composite tile and terrazzo flooring. In one embodiment, the first component constitutes between about 60 wt % and about 99 wt % of the coating formulation, more particularly, from about 70 wt % to about 99 wt % of the coating formulation, even more particularly, from about 80 wt % to about 99 wt % of the coating formulation. The coating formulation may have a weight ratio of polyol to polyisocyanate of from about 50:50 to about 99:1, more particularly, from about 60:40 to about 90:10, even more particularly, from about 75:25 to about 90:10.

The polyurethane coating material may include less than about 10 wt % wax, more particularly, less than about 8 wt % wax, even more particularly, less than about 5 wt % wax. The polyurethane coating material may also include less than about 30 wt % organic solvent, more particularly, less than about 15 wt % organic solvent, and even more particularly, less than about 5 wt % organic solvent. As such, the coating material of embodiments of the present invention may be considered VOC-compliant and/or VOC-free.

The polyurethane coating formulation may have a pot life, drying time, and viscosity that are better than conventional polyurethane coatings and/or are similar to acrylic finishes. For example, embodiments may have a pot life of at least 3 hours, more particularly, at least 5 hours, even more particularly, at least 8 hour, even more particularly 3-10 hours, and even more particularly, 6-8 hours. As used herein, the terms pot life refers to the time period during which a coating material has suitable properties (e.g., viscosity) for the intended flooring application procedures. For example, embodiments of the present invention have a viscosity of less than about 60 cps, more particularly, less than 25 cps, even more particularly, less than 10 cps, and even more particularly, less than 7 cps during the pot life when measured with a viscometer using a LV #1 spindle at 100 rpm at about 19° C. Viscosity may also be measured in terms of gloss properties as further set forth in Example 7 below.

The polyurethane coating formulations can be applied with traditional acrylic floor finish application methods, such as string mop and flat mop applications. Embodiments may have a drying time of between 15-60 minutes/coating, more particularly 20-45 minutes/coating. Moreover, floors coated with embodiments of the present invention are responsive to burnishing processes to restore gloss after normal wear on the coating has occurred. Suitable burnishing treatments include mechanical and chemical treatments. Compared to traditional zinc-based acrylic finishes, embodiments of the present invention have at least a 20% burnish response, more particularly, at least a 40% burnish response, even more particularly, at least a 60% burnish response, and even more particularly, at least an 80% burnish response. Additional details on burnish treatments and response are provided in Example 10 below.

Despite having application characteristics similar to acrylic finishes, embodiments of the present invention possess durability characteristics similar to conventional polyurethane finishes. Additionally, the resulting coating finish may possess improved black mark resistance compared to conventional polyurethane coating materials. One exemplary embodiment of the multi-component system includes the following:

TABLE 1

| Component 1 | | Component 2 | | Coating Material | |
|---|---|---|---|---|---|
| | wt % | | wt % | | wt % |
| Polyol | 30.0-60.0 | Isocyanate | 50.0-95.0 | Comp. 1 | 75.0-99.0 |
| (39% solids) | | | | | |
| DI H2O | 25.0-75.0 | Solvent | 0.0-50.0 | Comp. 2 | 1.0-25.0 |
| Surfactant | 0.0-1.0 | | | | |
| Defoamer | 0.0-1.0 | | | | |
| Wax | 0.0-5.0 | | | | |
| Total | 100.00 | | | | |
| % solids | 10.0-30.0 | | | | |

### EXAMPLES

TABLE 2
Material Summary

| Material | Description | Vendor |
|---|---|---|
| SF500 | NMP free version of QWF 4744 | Henkel |
| Tego Foamex 805 | Surfactant - polyether | Tego |
| | siloxane copolymer | |
| SE-21 | Defoamer | Wacker |
| Poly Emulsion 325G | Polyethylene wax | ChemCor |
| DPMA | Dipropylene glycol methyl | Multiple |
| | ether acetate | Sources |
| butoxyl | 3-methoxy-1-butanol acetate | Multiple |
| | | Sources |
| MarketStar | Zinc containing acrylic | Ecolab |
| | finish | |
| Bayhyddur XP 7165 | Polyisocyanate | Bayer |
| Bayhyddur 302 | Polyisocyanate | Bayer |
| Rhodocoat X EZ-M 502 | Polyisocyanate | Rhodia |
| Rhodocoat WT 2102 | Polyisocyanate | Rhodia |
| HW 100 | Polyisocyanate | BASF |
| Glosstek 100 | Three Component Polyurethane | Ecolab |
| | Coating Material | |
| A456-II | Quaternary disinfectant | Ecolab |

### Example 1

### Gloss Tests

Various samples of Component 1 and Component 2 were prepared as set forth in Tables 3 and 4 below. Component 1 in the amount of 22.1 g was placed into a glass vial and 1.23 g of Component 2 was then added. The vile was hand shaken for about 30 seconds and then allowed to stand for ten minutes. The resulting coating material was then hand coated using a microfiber pad onto a pre-scrubbed black vinyl composite tile (VCT) at ambient conditions (˜68 F/40% RH). The coating weight (wet) applied to the VCT was about 2000 ft2/gal of coating material. The coated tile was allowed air dry for about 30 minutes before applying an additional coat. A total of 6 coats of the finishes were applied in 2 days to the VCT for each Sample set forth below in Table 5. The 1st and 2nd coats were applied on the 1st day, and coats 3 to 6 were applied on the 2nd day.

TABLE 3

| | Component 1A | Component 1B | Component 1C |
|---|---|---|---|
| Materials | wt % | wt % | wt % |
| SF5000 | 44.80 | 44.19 | 43.75 |
| DI H2O | 52.04 | 51.33 | 50.82 |
| Tego Foamex 805 | 0.11 | 0.11 | 0.11 |
| SE-21/H2O (50/50) | 0.11 | 0.11 | 0.11 |
| Poly Emulsion 325G | 2.94 | 4.27 | 5.21 |
| Total | 100.00 | 100.00 | 100.00 |
| Approximate % solids | 18.50 | 18.73 | 18.89 |

TABLE 4

| | Component 2A | Component 2B |
|---|---|---|
| Materials | wt % | wt % |
| EZ-M502 | 85.0 | 85.0 |
| Butoxyl | 15.0 | |
| DPMA | | 15.0 |

TABLE 5

| | Component | Component | Component | Component | Component | |
|---|---|---|---|---|---|---|
| Samples | 1A | 1B | 1C | 2A | 2B | % solids |
| Sample 1 | 22.1 | | | 1.23 | | 22.01 |
| Sample 2 | | 22.1 | | | 1.23 | 22.22 |
| Sample 3 | | | 22.1 | 1.23 | | 22.38 |
| Sample 4 | | 22.1 | | 1.23 | | 22.22 |
| Sample 5 | MarketStar | | | | | 25 |

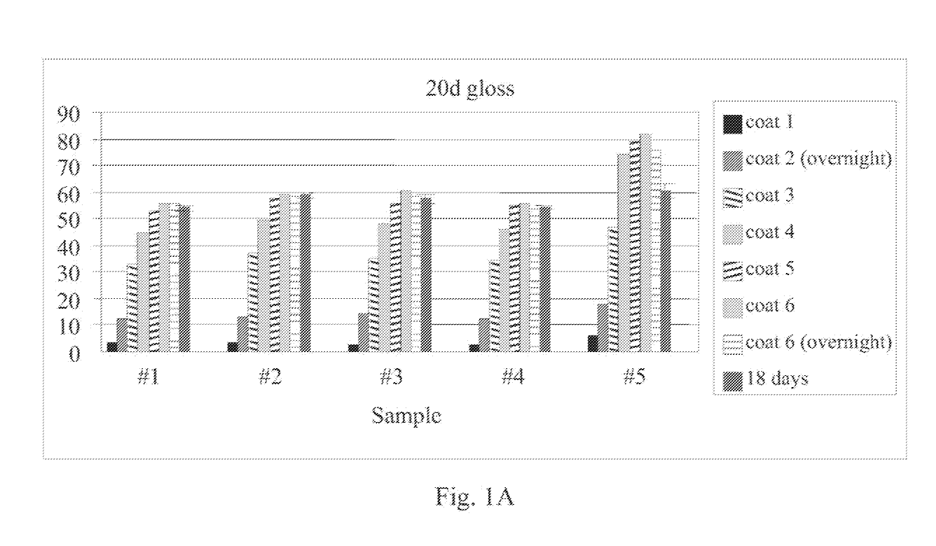

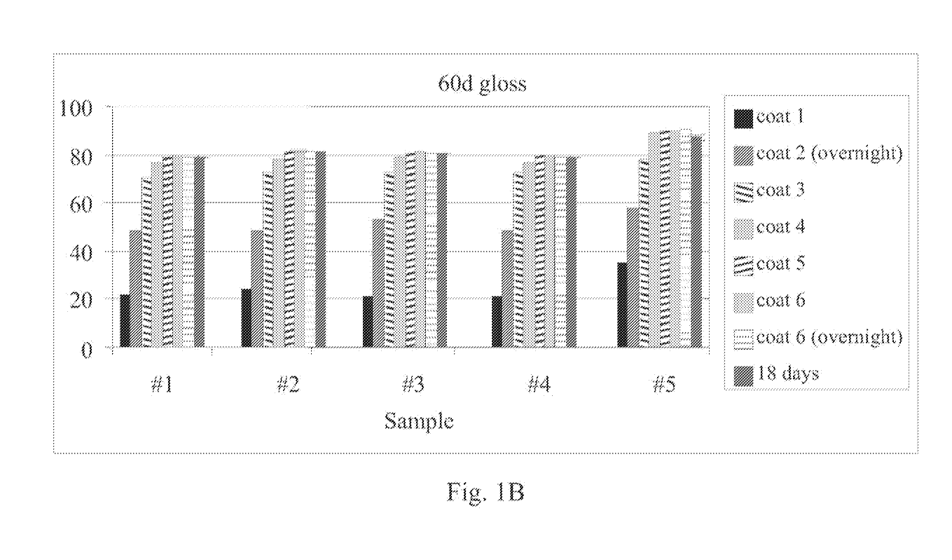

The results of these tests are shown in FIGS. 1A and 1B. The 20° gloss and 60° gloss measurements and the standard deviation were recorded using a BYK Gardner Micro-Tri-Gloss Meter. Each measurement was carried out after 30 minutes drying of the coating, except the 2nd coat and a second test of the 6 coat, both of which were measured after overnight drying. The final coat gloss was measured after overnight drying, as well as after 18 days on shelf aging.

The gloss results indicate that, although the acrylic finish of Sample 5 had higher application gloss, the formulas of Samples. 1-4 showed a lower 20° gloss reduction after drying/aging at ambient conditions. The gloss measured after about 20 days drying/aging showed that the 20° gloss of Samples. 1-4 were in the range of 54.1 to 58.9 with standard deviations of 0.9-1.5, and the acrylic finishes were about 60.5 to 63.7 with standard deviations of 2.2 to 2.8, respectively. Therefore the gloss of Samples 1-4 was close to the acrylic Sample 5 despite having a lower solids content than the acrylic finishes.

In addition, the results also showed that Samples 1-4 have a comparable drying time as the acrylic finish of Sample 5, which were in the range of less than 30 minutes at the coating environmental conditions. The experiments also demonstrated that Samples 1-4 had a sufficient pot life to allow at least four coating applications.

### Example 2

### Solvent

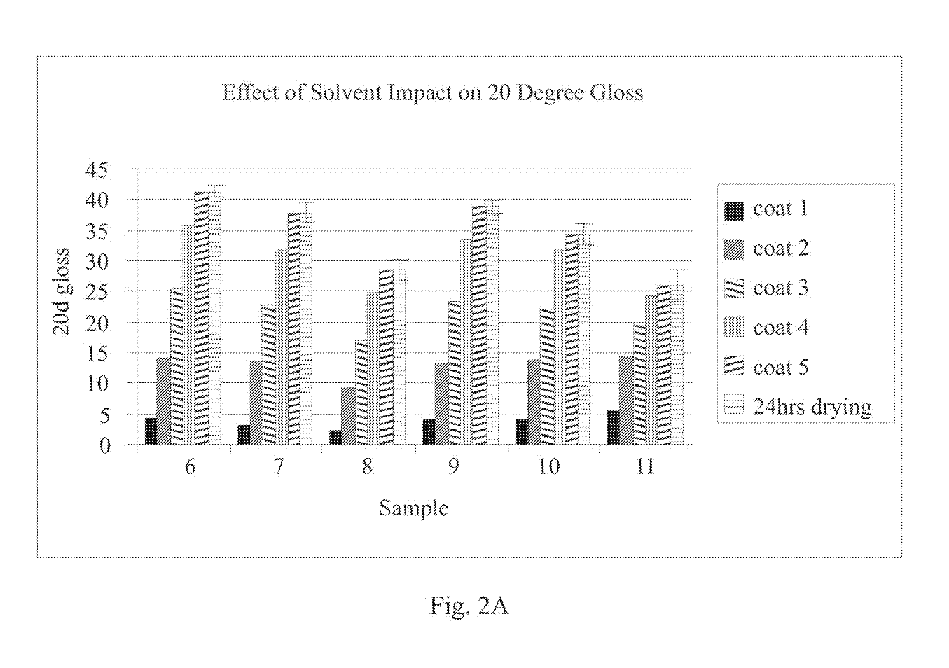

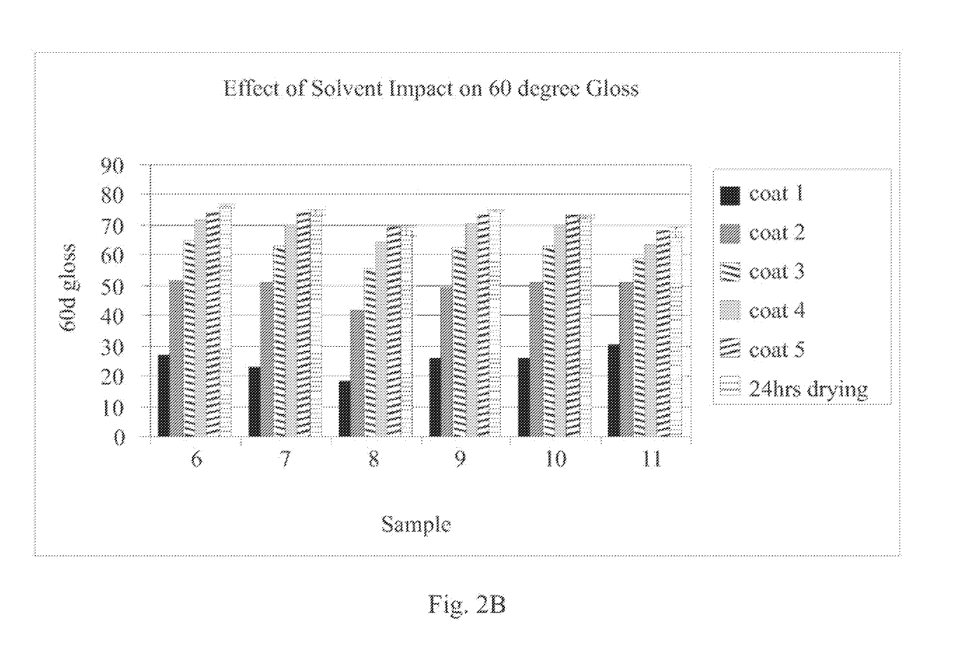

Component 1A from Example 1 was combined with Components 2A and 2B as set forth in Table 6 below. The resulting coatings were applied as described in Example 1 except that 5 coatings were applied in a single day. The gloss results are set forth in FIGS. 2A and 2B.

TABLE 6

| Samples | Comp. 1A | Comp. 2A | Comp. 2B | % solids |
|---|---|---|---|---|
| Sample 6 | 22.1 | 1.23 | | 22.01 |
| Sample 7 | 22.1 | 1.53 | | 22.81 |
| Sample 8 | 22.1 | 1.83 | | 23.59 |
| Sample 9 | 22.1 | | 1.23 | 22.01 |
| Sample 10 | 22.1 | | 1.53 | 22.81 |
| Sample 11 | 22.1 | | 1.83 | 23.59 |

The above gloss results indicate that, unlike traditional acrylic finishes, Samples 6-11 had a minimal gloss reduction after drying overnight. In addition, the results show that, at the same loading of Component 2, both solvents (butoxyl and DPMA) showed similar impact on gloss. However, as the Component 2 concentration or the ratio of isocyanate to polyol increased, the gloss of the finish reduced.

### Example 3

### Surface Abrasion

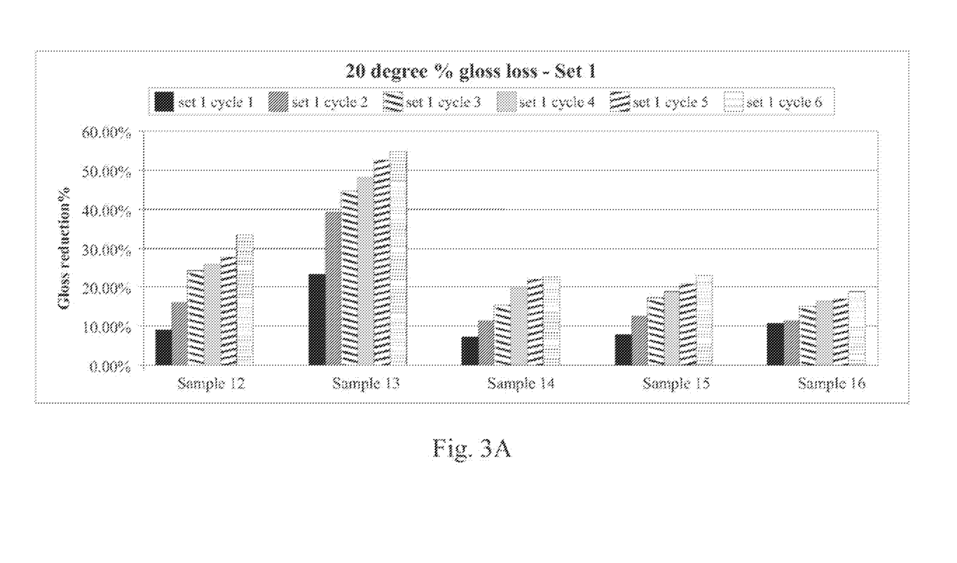

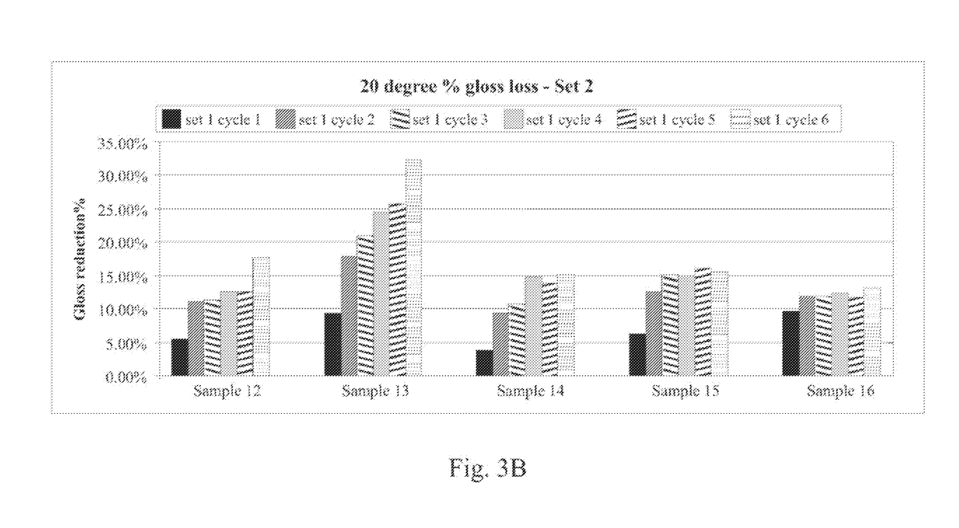

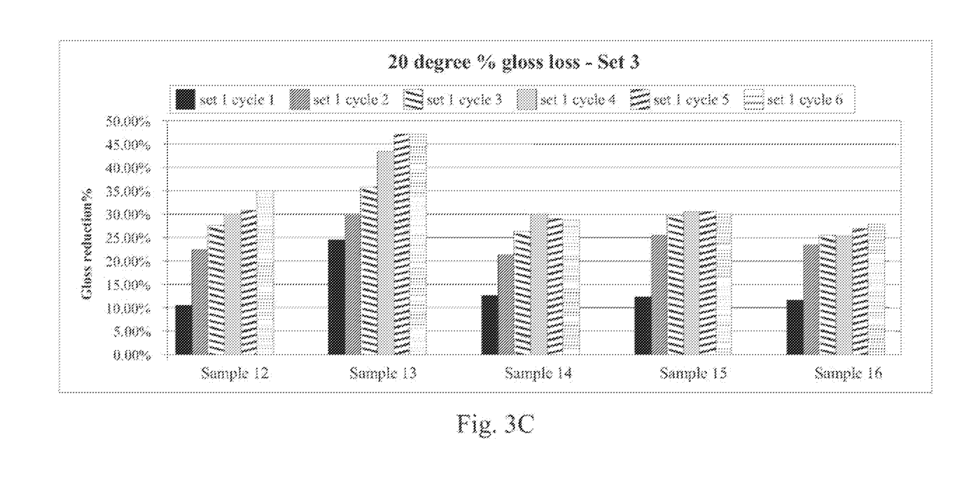

Components 1A-C were combined with Components 2A-B as set forth in Table 7. VCT substrates were then coated as set forth in Example 2 and initial gloss was measured as set forth in Table 8. Using a BYK-Gardner Abrasion Tester each Sample was then placed under a 3M Brand pink pad under 479 g weights. A total of six abrasion cycles were carried out and then gloss was re-measured. A second test was then applied to the Samples using a 3M brand pink pad under 941 g weights. A third test was then applied to the Samples using a 3M brand red pad under 941 g weights. The results of these tests are illustrated in FIGS. 3A, 3B and 3C. The gloss results over three tests were then averaged and are set forth in Table 9.

TABLE 7

| Samples | Comp. 1A | Comp. 1B | Comp. 1C | Comp. 2A | Comp. 2B | % solids |
|---|---|---|---|---|---|---|
| Sample 12 | 22.1 | | | 1.23 | | 22.01 |
| Sample 13 | MarketStar | | | | | |
| Sample 14 | | 22.1 | | 1.23 | | 22.22 |
| Sample 15 | | | 22.1 | 1.23 | | 22.38 |
| Sample 16 | | 22.1 | | | 1.23 | 22.22 |

TABLE 8

| Samples | 20° gloss | Std dev | 60° gloss | Std dev |
|---|---|---|---|---|
| Sample 12 | 54.7 | 2 | 81.5 | 1.4 |
| Sample 13 | 58.5 | 1.2 | 86.9 | 0.5 |
| Sample 14 | 53.4 | 1.9 | 79.8 | 0.8 |
| Sample 15 | 54.3 | 1.2 | 81.7 | 0.1 |
| Sample 16 | 49.9 | 0.5 | 82.5 | 0.1 |

TABLE 9

| | Average | Std | Average | Std | % loss | % loss |
|---|---|---|---|---|---|---|
| Sample | 20° | dev | 60° | dev | 20° | 60° |
| Sample 12 | 22.4 | 0.7 | 56.5 | 1 | 59.05% | 30.67% |
| Sample 13 | 11.2 | 0.3 | 35.4 | 0.5 | 80.85% | 59.26% |
| Sample 14 | 27 | 0.7 | 60 | 0.6 | 49.44% | 24.81% |
| Sample 15 | 26.4 | 0.7 | 58.5 | 0.2 | 51.38% | 28.40% |
| Sample 16 | 25.9 | 0.3 | 59.8 | 0.6 | 48.10% | 27.52% |

The above results indicate that Samples 12, 14, 15 and 16 showed significantly lower gloss reduction in contrast to the acrylic finish of Sample 13. For example, after 3 sets of testing, the 20° gloss reduction of Samples 12, 14, 15 and 16 was in the range of 48-59% while the acrylic finish Sample 13, lost about 80% gloss. The experiment demonstrates that compositions of the present invention have a higher surface wear resistance than the acrylic floor finishes.

### Example 4

### Durability Evaluation

The components of Samples 17-20 set forth in Table 10 below were combined in a glass vial, shaken for 30 seconds, and allowed to stand for 10 minutes. The mixtures were then coated onto a Leneta sheet with a Bird Applicator having a 3 mil wet thickness, and allowed to dry for at least seven days.

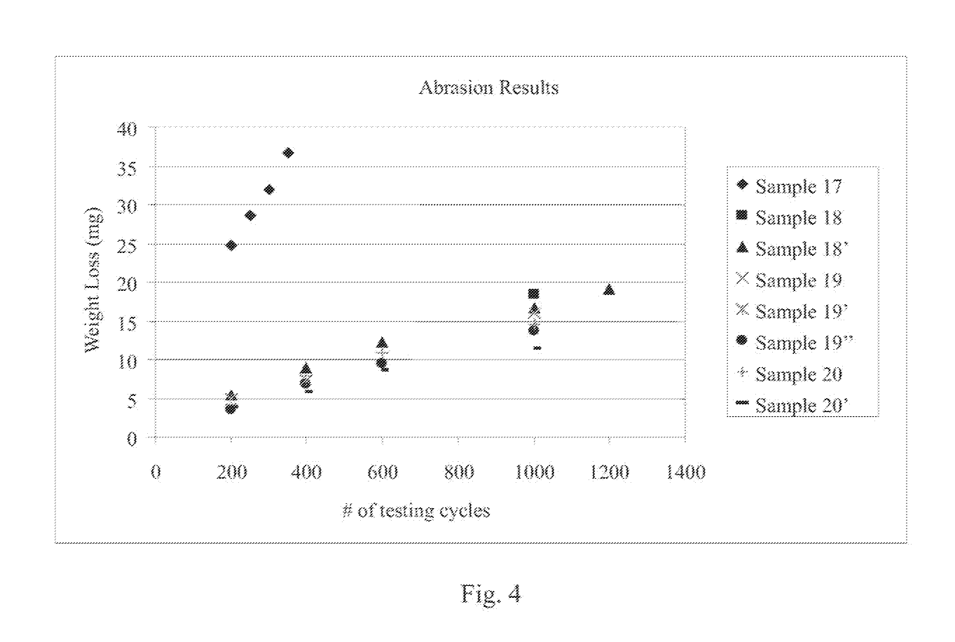

Abrasion was tested with a 5130 Abraser, manufactured by TABER Industries. CS-10 wheels were used for abrasion testing. A Specimen Mounting Card was used for supporting the coated Leneta sheets during the abrasion testing. A weight loading of 2×1000 g (2 wheels, each wheel 1000 g loading) was applied. The CS-10 wheels were treated with a Taber Abraser Refacing Disc for 50 cycles under 2×1000 g loading after each sample was run. Vacuum was used during the abrasion for all of the measurements to remove surface particles generated from the abrasion. The tests were carried out at ambient conditions at about 69-70 F/24-35% RH. Coating weight loss was measured for abrasion resistance evaluation as set forth in FIG. 4. Higher weight loss indicates a lower durability of resisting the wear.

TABLE 10

| Sample | Materials | | |
|---|---|---|---|
| Sample 17 | MarketStar | | |
| Sample 18 | Comp. 1A: | Comp. 2A: | |
| | 22.1 g | 1.23 g | |
| Sample 19 | Comp. 1A: | Comp. 2B: | |
| | 22.1 g | 1.23 g | |
| Sample 20 | Comp. 1A: | Comp. 2B: | Bindzil CC30: |
| | 22.1 g | 1.23 g | 0.221 g |

The results set forth in FIG. 4 show that Samples 18-20 had a significantly less weight loss than the acrylic finish (Sample 17) indicating these coatings are more durable than acrylic finishes.

### Example 5

### Mixing Evaluation

A variety of different polyisocyanate materials were combined with one or two different solvents as set forth in Table 11 below and shaken for at least two hours. Each of these materials were then combined with Component 1A as set forth in Table 12.

TABLE 11

| Comp. | Material | wt % | solvent | wt % |
|---|---|---|---|---|
| 2C | Bayhyddur XP 7165 | 85% | DPGDME | 15% |
| 2D | Bayhyddur 302 | 85% | DPGDME | 15% |
| 2E | Rhodocoat X EZ-M 502 | 85% | DPGDME | 15% |
| 2F | Rhodocoat WT 2102 | 85% | butoxyl | 15% |
| 2G | HW 100 | 85% | DPGDME | 15% |
| 2H | Bayhyddur XP 7165 | 85% | butoxyl | 15% |
| 2I | Bayhyddur 302 | 85% | butoxyl | 15% |
| 2J | Rhodocoat X EZ-M 502 | 85% | butoxyl | 15% |
| 2K | Rhodocoat WT 2102 | 85% | DPGDME | 15% |
| 2L | HW 100 | 85% | butoxyl | 15% |

TABLE 12

| | Component 1A (g) | Component 2 | Wt (g) |
|---|---|---|---|
| Sample 21 | 31.3 | 2C | 1.76 |
| Sample 22 | 31.3 | 2D | 1.76 |
| Sample 23 | 31.3 | 2E | 1.76 |
| Sample 24 | 31.3 | 2F | 1.76 |
| Sample 25 | 31.3 | 2G | 1.76 |
| Sample 26 | 31.3 | 2H | 1.76 |
| Sample 27 | 31.3 | 2I | 1.76 |
| Sample 28 | 31.3 | 2J | 1.76 |
| Sample 19 | 31.3 | 2K | 1.76 |
| Sample 30 | 31.3 | 2L | 1.76 |

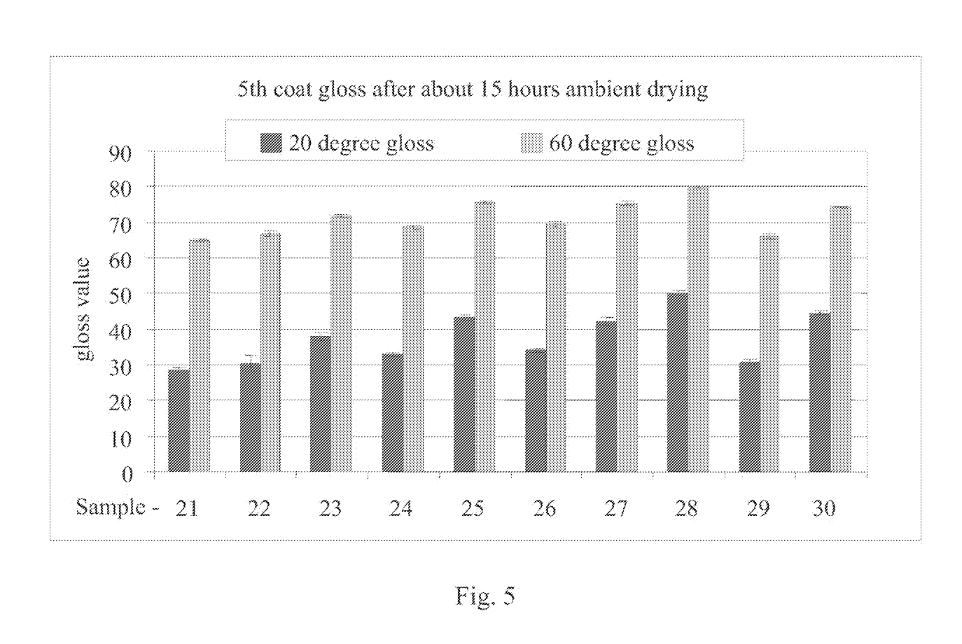

Each Sample was coated with a microfiber pad (˜1.5″×1.5″) on a pre-scrubbed black VCT at ambient (˜70 F/22% RH). The coating weight was controlled at about 2000 ft2/gal and air drying time was about 30 minutes for each coat, except the 1^{st} coat, which was dried for about one hour. 20 and 60 degree gloss and the standard deviation of each coat were recorded with BYK Gardner Micro-Tri-Gloss Meter. The final gloss was measured on the 5^{th} coat after about 15 hours drying. The results are set forth in FIG. 5.

A mixture uniformity evaluation was carried out by pouring away the liquid after completing the coating and examining the liquid residue at the bottom of the mixing container. A visual uniformity rating was then assigned as set forth in Table 13, with a higher number of uniformity indicating a better mixing.

TABLE 13

| | Uniformity | | Uniformity | | |
|---|---|---|---|---|---|
| | rating | | rating | Uniformity description | Ratings |
| Sample 21 | 2 | Sample 26 | 2 | significant non-uniform | 1 |
| Sample 22 | 1 | Sample 27 | 1 | non-uniform mixing | 2 |
| Sample 23 | 5 | Sample 28 | 5 | slightly non-uniform | 3 |
| Sample 24 | 3 | Sample 29 | 3 | very slightly non-uniform | 4 |
| Sample 25 | 3 | Sample 30 | 4 | uniform mixing | 5 |

The above results showed that Samples 23 and 28, can be formulated with an adequate combination of isocyanate and solvent to deliver a formulation with uniform mixing and good application gloss.

### Example 6

### Alcohol Resistance

Samples 32-34 set forth in Table 14 compare the alcohol resistance of commercially available floor finishes to Sample 31, an embodiment of the present invention. Glosstek 100 is a commercially available 3 component polyurethane system requiring 6-8 hours drying time per coat and a has a pot life of less than 90 minutes. MarketStar is a commercially available zinc containing acrylic floor finish. Lucent is a commercially available urethane fortified acrylic floor finish.

TABLE 14

| Condition | Sample 31 | Sample 32 | Sample 33 | Sample 34 |
|---|---|---|---|---|
| Finish | Table 15 | Glosstek 100 | MarketStar | Lucent |

TABLE 15

| Component 1A | | Component 2B | | Sample 31 | |
|---|---|---|---|---|---|
| | wt % | | wt % | | wt % |
| SF 5000 | 44.80 | EZ-M502 | 85.0 | 1A | 94.72% |
| DI H2O | 52.04 | DPMA | 15.0 | 2B | 5.28% |
| Tego Foamex 805 | 0.11 | | | | |
| SE-21/H2O (50/50) | 0.11 | | | | |
| 325G | 2.94 | | | | |
| Total | 100.00 | | | | |
| % solids | 18.50 | | | | |

Sample 31 was prepared by adding part 2B to part 1A in a glass vial, shaking, and allowing to settle for 20 minutes prior to use. The remaining samples were mixed as per instructions or used as is. The coatings of Samples 31, and 33-34 were applied by hand coating with a microfiber pad (˜1.5″×1.5″) on a pre-scrubbed black VCT at ambient conditions (72° F./43% RH). The coating weight (wet) was controlled at about 2000 ft2/gal and the coating was air died for about 30 minutes before applying the next coat. Total 5 coats of the finishes were applied in one day. For Sample 32, one layer was coated at about 400 ft²/gal with a ⅜″ soft woven roller on a pre-scrubbed black VCT at ambient conditions.

The coated substrates were then contacted with Endure 300, an alcohol containing hand sanitizing gel, for 95 minutes by placing a quarter-sized drop of the alcohol hand sanitizer to the coated surface. After 95 minutes the sanitizer was wiped away with a wet paper towel. The contact area was analyzed for 60 degree gloss and percent gloss loss (Original gloss−tested area gloss/original gloss) using a BYK Gardner Spectro-Guide. The results of these tests are set forth in Tables 16.

TABLE 16

| | Original | Tested Area | Delta |
|---|---|---|---|
| Sample | 60° Gloss | 60° Gloss | 60° Gloss |
| 31 | 71.50 | 61.90 | 9.60 |
| 32 | 88.07 | 86.50 | 1.57 |
| 33 | 82.77 | 5.90 | 76.87 |
| 34 | 85.57 | 24.07 | 61.50 |

The result indicate that Sample 31, an embodiment of the present invention had significantly lower gloss loss than samples 33 and 34, with only sample 32 (a three component system) providing slightly better performance.

The degree of whitening caused by the alcohol was measured using a BYK Gardner Spectro-Guide with Delta L being measured as Original L−Tested Area L. The results are set forth in Table 17.

TABLE 17

| Condition | Original L | Tested Area L | Delta L |
|---|---|---|---|
| 31 | 12.01 | 13.90 | −1.89 |
| 32 | 6.23 | 6.56 | −0.33 |
| 33 | 6.72 | 64.77 | −58.06 |
| 34 | 7.56 | 31.10 | −23.55 |

The results indicate that Sample 31 had a lower degree of whitening than Examples 33 and 34 and only a slightly higher degree of whitening than sample 32.

The visual appearance of the Sample tiles was also determined based on a 0 to 3 scale with 0 meaning that the alcohol did not impact the tested surface and a 3 meaning a significant impact on the tested surface. The Visual parameters set forth in Table 18 were tested, with results set forth in Table 19

TABLE 18

| | |
|---|---|
| Whiteness | Degree tested spot turned to white color |
| Residue gel | Amount of dried alcohol gel retained on |
| | the surface, and ability to wipe with |
| | wet paper towel |
| Blistering | Extent to which pin hole sized blisters |
| | are formed in the tested area |
| visible gel | Degree that tested spot is visible |
| Gloss Loss | Degree of gloss loss on the tested spot |

TABLE 19

| | Residue | Small | Visible | Gloss | Film | Total |
|---|---|---|---|---|---|---|
| Sample | Gel | Blisters | Gel Mark | Loss | Whiteness | Rating |
| 31 | 0 | 0.5 | 0 | 0.5 | 0 | 1 |
| 32 | 0 | 0 | 0 | 0 | 0 | 0 |
| 33 | 2 | 0 | 3 | 3 | 3 | 11 |
| 34 | 2 | 0 | 3 | 3 | 2.5 | 10.5 |

The total rating of the appearance change after the alcohol gel test shows that Sample 31 had a lower appearance change rating than Samples 33-34, with Sample 32 providing only a slightly better appearance improvement.

### Example 7

### Pot Life

Samples 35-39 set forth in tables 20-23 below were for viscosity stability and coating appearance. To measure viscosity for Samples 35-38, Component 1 and 2 were mixed and the viscosity of the mixture was measured about 20 minutes later after mixing commenced using a Brookfield Model LVDV-II+ with spindle LV#1 at 100 rpm and at ambient (about 19° C.) and at various times thereafter as set forth in Table 22 below. Due to the higher viscosity of Sample 39, an LV#2 spindle at 20 rpm was used.

TABLE 20

| Material | Comp. 1A | Comp. 1D |
|---|---|---|
| SF 5000 | 44.8 | 47.74 |
| DI H2O | 52.04 | 52.04 |
| Tego Foamex 805 | 0.11 | 0.11 |
| SE-21/H2O (50/50) | 0.11 | 0.11 |
| 325G | 2.94 | 0 |
| Total | 100 | 100 |
| % solids | 18.5 | 18.5 |

TABLE 21

| Material | Comp. 2A | Comp. 2B |
|---|---|---|
| EZ-M502 | 85 | 85 |
| DPMA | | 15 |
| Butoxyl | 15 | |

TABLE 22

| Samples | Finish | Comp A1:Comp 2 |
|---|---|---|
| 35 | 1A + 2B | 94.72:5.28 |
| 36 | 1A + 2A | 94.72:5.28 |
| 37 | 1D + 2B | 94.72:5.28 |
| 38 | 1D + 2A | 94.72:5.28 |
| 39 | GlossTek 100 | |

TABLE 23

| | Viscosity (cP) | | | | |
|---|---|---|---|---|---|
| Time after | LV Spindle #1 at 100 rpm | | | | LV #2 @ 20 rpm |
| mixing | 35 | 36 | 37 | 38 | 39 |
| 0:20:00 | 6.18 | 6.96 | 6.6 | 6.54 | 1125 |
| 1:20:00 | 6.66 | 6.42 | 6.54 | 6.54 | SOLIDIFICATION |
| 2:20:00 | 6.42 | 6.42 | 6.24 | 6.54 | |
| 3:20:00 | 6.42 | 6.6 | 6.6 | 6.6 | |
| 4:20:00 | 6.6 | 6.66 | 6.78 | 6.84 | |
| 5:20:00 | 6.6 | 6.6 | 6.6 | 6.54 | |
| 6:20:00 | 6.6 | 6.72 | 6.3 | 6.3 | |
| 7:20:00 | 5.88 | 6.3 | 6.3 | 6.54 | |
| 8:20:00 | 6 | 6.36 | 6.36 | 6.3 | |
| 8:50:00 | 6.72 | 6.84 | 6.3 | 6.06 | |

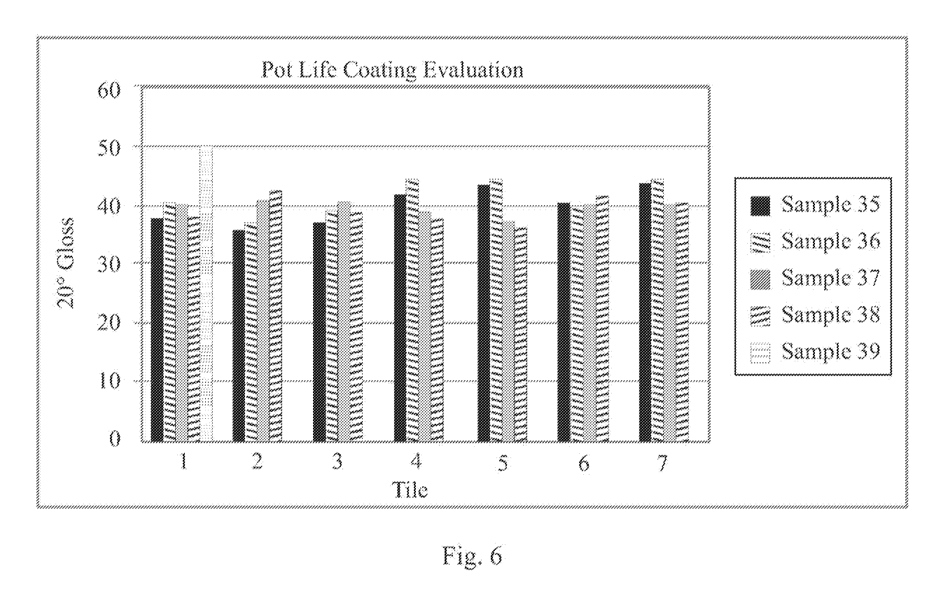

For Samples 35-38 coating appearance was measured by coating the mixture onto a black VCT substrate at a rate of about 2000 ft²/gal with a microfiber pad. Five coats were applied on one VCT tile and 30 minutes drying time was allowed for each coat to dry. Gloss was measured for each coat after drying. For Sample 39, one coating was applied at a rate of 400 ft²/gal with a ⅜″ soft roller. These steps were repeated on a new tile every hour until 7 tiles were completed and tested for gloss. The results are set summarized in FIG. 6.

The example shows that embodiments of the present invention have a pot life, at ambient, greater than 8 hours measured by coating gloss and greater than 8.5 hours measured by viscosity. The 8 hour gloss pot life conclusion was reached because the last coat was applied at 8 hours and 20 minutes after the coating solution was mixed with a desirable dry coat result.

### Example 8

### Black Mark/Scuff Resistance Evaluation

Coating solutions 40-46 set forth in Tables 24-26 were prepared by adding Component 2 to Component 1, mixing for about one minute and allowing the mix to stand for at least 10 minutes before coating. The finished coating solutions were applied with a microfiber pad on a pre-cleaned white VCT tile at about 2000 ft2/gal with 30 minutes drying time for each coat. A total of 5 coats were applied at ambient conditions.

Black mark resistance testing was performed using a scuff-ladder apparatus with black rubber footing after the coatings were aged for about 5 months. The testing was carried out under ambient conditions. Both L and Wb values set forth in Table 27 were recorded with a Gardner SpectroGuide before and after scuffing. The average value was calculated based on 4 scruff mark measurements. A higher L value or higher Wb value after scuffing indicates a better scuff resistance.

Two of the scruff marks were further hand wiped with a dry paper towel 3 times with low pressure. The L and Wb values were measured after wiping. A higher value change after the wiping indicates a better black mark/scuff removal.

TABLE 24

| | Component 1E | Component 1F | Component 1G |
|---|---|---|---|
| Comp. 1 Materials | wt % | wt % | wt % |
| SF-5000 | 46.15 | 44.80 | 44.80 |
| DI H2O | 53.63 | 52.04 | 52.04 |
| Tego Foamex 805 | 0.11 | 0.11 | 0.11 |
| SE-21/H2O (50/50) | 0.11 | 0.11 | 0.11 |
| Poly Emulsion 325G | | 2.94 | 2.94 |
| Conrez 510 | | | 2.00 |
| Total | 100.00 | 100.00 | 102.00 |

TABLE 25

| | Component 2M | Component 2N |
|---|---|---|
| Comp. 2 Materials | wt % | wt % |
| Rhodocoat X EZ-M 502 | 50 | 85 |
| Rhodocoat X EZ-D 803 | 50 | |
| (70% in butoxyl) | | |
| butoxyl | | 15 |

TABLE 26

| Samples | Components | Comp. 1:Comp. 2 |
|---|---|---|
| Sample 40 | Stratus | |
| Sample 41 | Comp. 1E + Comp. 2M | 94.7:5.3 |
| Sample 42 | Comp. 1F + Comp. 2M | 94.7:5.3 |
| Sample 43 | Comp. 1G + Comp. 2M | 94.7:5.3 |
| Sample 44 | Comp. 1E + Comp. 2N | 94.7:5.3 |
| Sample 45 | Comp. 1F + Comp. 2N | 94.7:5.3 |
| Sample 46 | Comp. 1G + Comp. 2N | 94.7:5.3 |

TABLE 27

| | Samp. | Samp. | Samp. | Samp. | Samp. | Samp. | Samp. |
|---|---|---|---|---|---|---|---|
| | 40 | 41 | 42 | 43 | 44 | 45 | 46 |
| L average | 84.31 | 85.90 | 85.87 | 86.20 | 85.93 | 85.88 | 84.94 |
| Initial | | | | | | | |
| L average | 79.56 | 75.60 | 82.50 | 81.08 | 76.54 | 81.45 | 80.66 |
| after scuff | | | | | | | |
| L average | 82.73 | 79.93 | 85.08 | 84.40 | 81.14 | 84.49 | 83.68 |
| after wipe | | | | | | | |
| Delta L | 4.75 | 10.30 | 3.37 | 5.12 | 9.39 | 4.43 | 4.27 |
| after scuff | | | | | | | |
| Delta L | 1.58 | 5.97 | 0.79 | 1.80 | 4.79 | 1.39 | 1.26 |
| after wipe | | | | | | | |
| WB average | 40.94 | 41.94 | 41.67 | 38.28 | 40.88 | 41.70 | 40.39 |
| Initial | | | | | | | |
| WB average | 35.05 | 28.82 | 36.49 | 31.60 | 29.39 | 35.68 | 35.15 |
| after scuff | | | | | | | |
| WB average | 38.49 | 33.48 | 39.47 | 34.61 | 33.76 | 39.35 | 38.29 |
| after wipe | | | | | | | |
| Delta WB | 5.89 | 10.30 | 3.37 | 5.12 | 9.39 | 4.43 | 5.24 |
| after scuff | | | | | | | |
| Delta WB | 2.46 | 8.47 | 2.21 | 3.67 | 7.13 | 2.35 | 2.11 |
| after wipe | | | | | | | |

The results show that Samples 42-44 had a lower delta L after scuffing than Sample 41 indicating that the addition of the wax improved the black mark/scuff resistance. Similar results were demonstrated by Samples 45-46, in contrast to Sample 44, a formula containing no wax.

The example also demonstrated that the coating formulas according to the present invention provide scuff/black mark resistance and removal characteristics comparable to the traditional acrylic floor finish.

### Example 9

### Quaternary Amine Disinfectant Resistance Evaluation

The quaternary amine disinfectant resistance of embodiments of the present invention set forth in Tables 27-28 was evaluated in comparison to MarketStar, a traditional acrylic floor finish. For Samples 47-48, Component 2 was added to Component A in a beaker, mixed for about one minute, and then allowed to stand 15 minutes before use. Samples 49-54, were used as commercially provided.

For all samples, the finish was hand coated with a microfiber pad (˜1.5″×1.5″) on a pre-scrubbed black VCT at ambient conditions (72° F./43% RH). Application was controlled at about 2000 ft2/gal. The coating was allowed to air dry for about 30 minutes before applying the next coat. A total of 5 coats of the finishes were applied in one day. The coated tiles were allowed to cure at ambient conditions for at least five days before beginning the solution application.

The sample tiles were then cut into 2″ by 10.5″ coupons. On the day of the quaternary disinfectant treatment procedure, a 0.5 oz/gal A456II dilution was prepared by adding the A456II concentrate to deionized water and saturating two 2″ by 2″, 8 ply Kendall Curity Gauze Sponge with approximately 1000-1500 uL 0.5 oz/gal solution of the A456II.

To each quaternary disinfectant treatment Sample (47-48, 51-52), the following application procedure was used for a total of six applications with at least a 20 minute dry time between each application. Using a micropipette, 250 uL of the A456II solution was dispensed directly to the pre-saturated gauze pads. The A456II solution was applied to the sample coupon by lightly wiping the pre-saturated gauze pads over the coupon surface with 1-2 passes leaving approximately 0.20 g-0.25 g of solution on the coupon surface.

After the sixth A456-II solution treatment, the coupons were allowed to stand under ambient conditions for at least 12 hours before beginning the soil procedure #1 discussed below. The soil procedure #1 was conducted within 12-24 hours after the sixth A456II solution treatment.

The soiling procedure was carried out with two sets of treated coupons soiled and compared to an untreated MarketStar sample. Each set of the sample was soiled in one of two drums. The Wb color data was collected with the BYK Gardner SpectroGuide to measure the degree of soiling. A higher delta Wb (Wb before soiling−Wb after soiling) indicates a poorer soiling resistance. For the set 1, the Wb value was collected as an average of five measurements collected along the length of the coupon. For set 2 five individual measurements were taken and averaged manually.

For both drums, an initial (0 min) Wb color data was taken with the BYK Gardner Spectroguide for each coupon. Each coupon was taped into the drum with the coated side of the coupon facing the inside of the drum. 100 g of freshly prepared soiled nylon pellets were then added to the drum. The lid of the drum was secured and the soiled pellets were distributed throughout the drum. The drum was then placed on a set of rollers and rotated at a constant speed for a total of 60 minutes. Wb color data was collected after 15 minutes and 60 minutes of soiling. The 60 minute soiling results are listed in Table 30 below.

TABLE 28

| Component 1A | | Component 2A | | Mixing ratio | |
|---|---|---|---|---|---|
| | wt % | | wt % | | wt % |
| SF 5000 | 44.80 | EZ-M502 | 85.0 | Comp. 1A | 94.72% |
| DI H2O | 52.04 | DPMA | 15.0 | Comp. 2A | 5.28% |
| Tego Foamex 805 | 0.11 | | | | |
| SE-21/H2O (50/50) | 0.11 | | | | |
| Poly Emulsion 325G | 2.94 | | | | |
| Total | 100.00 | | | | |
| % solids | 18.50 | | | | |

TABLE 29

| | | | Quaternary Disinfectant |
|---|---|---|---|
| Sample | drum | Floor Finish | Treatment |
| 47 | 1 | Table 24 formula | A456II - 0.5 oz/gal |
| 48 | 1 | Table 24 formula | A456II - 0.5 oz/gal |
| 49 | 1 | MarketStar | None |
| 50 | 1 | MarketStar | None |
| 51 | 2 | MarketStar | A456II - 0.5 oz/gal |
| 52 | 2 | MarketStar | A456II - 0.5 oz/gal |
| 53 | 2 | MarketStar | None |
| 54 | 2 | MarketStar | None |

TABLE 30

| | | Before | After | |
|---|---|---|---|---|
| | | Soil | 60 minutes | Delta Wb |
| Condition | drum | avg. Wb | Soil avg. Wb | (before − After) |
| 47 | 1 | 62.58 | 47.46 | 15.12 |
| 48 | 1 | 62.5 | 47.34 | 15.16 |
| 49 | 1 | 64.93 | 48.33 | 16.6 |
| 50 | 1 | 64.24 | 50.01 | 14.23 |
| 51 | 2 | 65.97 | 40.09 | 25.88 |
| 52 | 2 | 65.83 | 43.22 | 22.61 |
| 53 | 2 | 64.24 | 48.24 | 16 |
| 54 | 2 | 65.89 | 50.22 | 15.67 |

The above data shows that, for drum 1, the Wb change for the quaternary amine disinfectant treated invention formula of Samples 47 and 48, was about 15 and the non-quaternary amine disinfectant treated acrylic finish (Samples 49-50) was in the range of 14.2 to 16.6, respectively. In contrast, the drum 2 data shows that the quaternary amine disinfectant treated acrylic finish of Samples 51-52 had a significant higher delta Wb after soiling (about 22.6 to 25.9) in comparison to non-quaternary amine disinfectant treated Samples 53-54, which had a Wb change of about 16.

The results indicate that embodiments of the present invention, after being treated with the quaternary amine disinfectant, exhibited a significantly higher quaternary amine disinfectant resistance than the acrylic coatings. The quaternary amine disinfectant treated embodiments of the present invention showed similar floor appearance to the acrylic finishes that were not treated with the quaternary amine disinfectant cleaner.

### Example 10

### Burnish Response

Samples 55-57 set forth in Table 31 below were tested to determine the effect of contacting coated vinyl composite flooring with a burnishing pad. For Sample 55, five coatings were applied to a floor sample at 2000 ft²/gallon with a microfiber pad with 30-60 minute dry time in between coating applications. For Sample 56, three coats were applied to a floor sample at 2000 sqft/gallon with a microfiber pad with 30-60 minute dry time in between coating applications. For Sample 57, which is a high solids polyurethane material, one layer was applied at about 400 ft²/gallon with a roller.

TABLE 31

| Sample | 55 | 56 | 57 |
|---|---|---|---|
| Finish | MarketStar | Sample 36 from Example 7 | Glosstek 100 |

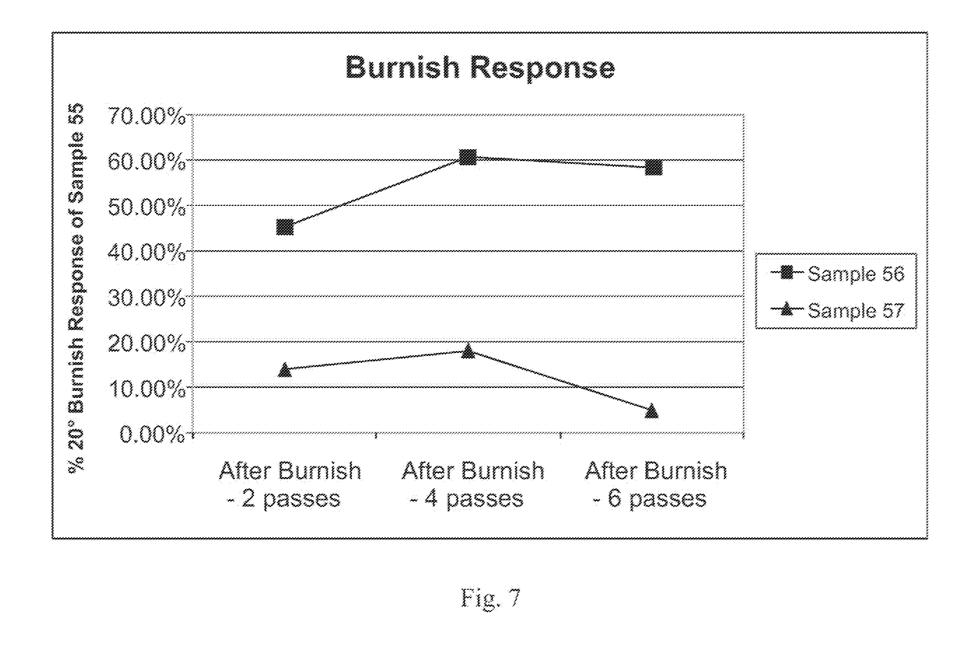

Burnish response was tested by wearing the coating with 2 passes of a 3M brand surface preparation pad loaded onto a Tennant T3 brand autoscrubber. Dust was then removed from the test area and a total of six passes was then made with an electric UHS Whirlmatic Burnisher loaded with a 3300 natural blend pad. 20° gloss and 60° gloss was measured after every other pass (i.e., after two passes). The results are set forth in Tables 32 and 33 and FIG. 7.

TABLE 32

| | | 20° | | 60° | | Delta | 20° % |
|---|---|---|---|---|---|---|---|
| Sample | Description | Gloss | s.d | Gloss | s.d | 20° | Change |
| Sample 55 | After Wear with Maroon Pad | 1.4 | 0.1 | 8.7 | 0.7 | n/a | n/a |
| Sample 55 | After Burnish - 2 passes | 14.5 | 3.4 | 45.5 | 4.9 | 13.1 | 935.71% |
| Sample 55 | After Burnish - 4 passes | 23.1 | 6.5 | 54.6 | 6.4 | 21.7 | 1550.00% |
| Sample 55 | After Burnish - 6 passes | 31.3 | 6.2 | 63.3 | 6.2 | 29.9 | 2135.71% |
| Sample 56 | After Wear with Maroon Pad | 0.6 | 0.1 | 4.7 | 0.5 | n/a | n/a |
| Sample 56 | After Burnish - 2 passes | 6.5 | 0.8 | 23.2 | 2.8 | 5.9 | 983.33% |
| Sample 56 | After Burnish - 4 passes | 13.7 | 2.6 | 38.9 | 5.6 | 13.1 | 2183.33% |
| Sample 56 | After Burnish - 6 passes | 18 | 2.6 | 45.8 | 5.4 | 17.4 | 2900.00% |
| Sample 57 | After Wear with Maroon Pad | 2.3 | 0.6 | 8.8 | 2.7 | n/a | n/a |
| Sample 57 | After Burnish - 2 passes | 4.1 | 1.9 | 14.4 | 4.1 | 1.8 | 78.26% |
| Sample 57 | After Burnish - 4 passes | 6.2 | 3.7 | 19 | 4.3 | 3.9 | 169.57% |
| Sample 57 | After Burnish - 6 passes | 3.7 | 1.4 | 11.7 | 1.6 | 1.4 | 60.87% |

TABLE 33

| | | % 20° Burnish Response in |
|---|---|---|
| | | comparison to Sample 55 |
| Sample | Description | (Delta Sample/ Delta Sample 55) |
| Sample 56 | After Burnish - 2 passes | 45.04% |
| Sample 56 | After Burnish - 4 passes | 60.37% |
| Sample 56 | After Burnish - 6 passes | 58.19% |
| Sample 57 | After Burnish - 2 passes | 13.74% |
| Sample 57 | After Burnish - 4 passes | 17.97% |
| Sample 57 | After Burnish - 6 passes | 4.68% |

The results set forth in Tables 32 and 33 and in FIG. 7 demonstrate that, when compared to the acrylic coating of Sample 55, Sample 56 has a better burnishing response than Sample 57. Notably, Sample 56 had 45-60% of the burnish response of Sample 55, while Sample 57 had only about 4-18% response. The data also indicates a higher percent burnishing response (e.g., at least 80%) would be possible when compared to other zinc-based acrylic coating materials.

Although the present invention has been described with reference to preferred embodiments, workers skilled in the art will recognize that changes may be made in form and detail without departing from the spirit and scope of the invention.

1. A floor coating composition comprising:
an aqueous dispersion of at least one polyurethane material; and
a solvent system comprising no more than 1 wt % organic solvent having a vapor pressure of greater than 0.1 mm Hg at 20° C.,
wherein the composition has a viscosity of less than 60 cps under ambient conditions for at least three hours after the composition is formed.

2. The coating composition of claim 1 wherein the solvent system comprises at least one aprotic solvent.

3. The coating composition of claim 1 wherein the solvent system comprises at least one aprotic solvent having a vapor pressure of less than 0.1 mm Hg at 20° C.

4. The coating composition of claim 1 wherein the solvent system comprises at least one ether ester.

5. The coating composition of claim 1 wherein the solvent system comprises at least one acetate solvent.

6. The coating composition of claim 5 wherein the at least one acetate solvent comprises an aliphatic glycol alkyl ether acetate solvent.

7. The coating composition of claim 5 wherein the at least one acetate solvent comprises dipropylene glycol methyl ether acetate solvent.

8. The coating composition of claim 1 wherein the at least one acetate solvent comprises 3-methoxybutyl acetate solvent.

9. The coating composition of claim 1 wherein the coating composition has a viscosity of less than 60 cps for at least 6 hours after the composition is formed.

10. The coating composition of claim 1 wherein the coating composition has a viscosity of less than 25 cps for at least 6 hours after the composition is formed.

11. The coating composition of claim 1 wherein the coating composition has a viscosity of less than 10 cps for at least 6 hours after the composition is formed.

12. The coating composition of claim 1 comprising at least one wax.

13. The floor system of claim 12 wherein the wax material comprises a polyethylene wax, a polypropylene wax or a mixture thereof.

14. A floor finish system comprising:
a first component comprising at least one polyol or polyol derivative; and
a second component including at least one polyisocyanate or polyisocyanate derivative;
wherein the first and second components are free of N-methylpyrrolidone and include no more than 1 wt % organic solvent having a vapor pressure of greater than 0.1 mm Hg at 20° C. based on the total weight of the first and second components; and
wherein if the first and second components are combined, the system has a viscosity of less than 60 cps under ambient conditions for at least three hours after the composition is formed.

15. The floor finish system of claim 14 wherein the first and second components are contained in separate reservoirs.

16. The floor finish system of claim 15 wherein the first component is an aqueous dispersion of at least one polyol.

17. The floor finish system of claim 16 wherein the first component has a total solids content of less than 25 wt %.

18. The floor finish system of claim 14 wherein the second component comprises at least one aprotic solvent.

19. The floor finish system of claim 14 wherein the polyol and polyisocyanate comprise polymer segments of a polyurethane material.

20. The floor system of claim 14 further comprising a polyethylene wax, a polypropylene wax, or a mixture thereof.

21. A method of coating a floor comprising:
applying at least one layer of a coating material to a floor surface, wherein the coating material has a viscosity of not more than 60 cps for at least 3 hours after the composition is formed, the coating material comprising:
an aqueous dispersion of at least one polyurethane material; and
no more than 1 wt % organic solvent having a vapor pressure of greater than 0.1 mm Hg at 20° C. based on the total weight of the first and second components.

22. The method of claim 21 comprising, prior to the applying step, combining a first component and a second component to form the coating material, the first component comprising an aqueous dispersion including at least one polyol material, and the second component including at least one isocyanate material.

23. The method of claim 21 wherein the applying step comprises applying the coating material with a string mop, flat mop or sponge applicator.

24. The method of claim 21 further comprising the step of burnishing the coated floor.
